(19) United States
(12) Patent Application Publication
(10) Pub. No.: US 2008/0067217 A1
(43) Pub. Date: Mar. 20, 2008

(54) Connection of a steel fastening element to a flat aluminium component

(75) Inventors: Wilfried Pinzl, Tambach-Dietharz (DE); Eberhard Christ, Tambach-Dietharz (DE)

Correspondence Address: BIRCH STEWART KOLASCH & BIRCH, PO BOX 747, FALLS CHURCH, VA, 22040-0747, US

(73) Assignee: EJOT GmbH & Co. KG, Bad Laasphe (DE)

(21) Appl. No.: 11/902,188

(22) Filed: Sep. 19, 2007

(30) Foreign Application Priority Data
Sep. 20, 2006 (DE) 10 2006 044 379.9

(51) Int. Cl. B23K 20/12

(52) U.S. Cl. 228/114.5

(57) ABSTRACT

The invention relates to a connection of a rotationally symmetrical steel fastening element to a flat aluminium component. The fastening element is provided with an electroplated aluminum coating and, at its end facing the component, forms a cone with a cone angle of at least α=174°, wherein, through rotation and pressing against the component, said cone is superficially connected thereto by means of a friction-welding zone.

The invention relates to a connection of a rotationally symmetrical steel fastening element to a flat aluminium component, of the type presented in conjunction with a multi-part assembly in DE 196 20 814 A1. Said publication describes a process for producing said multi-part assembly in which two flat, superimposed aluminium components are joined together by friction-welding by means of a steel connecting part, the connecting part penetrating through the upper of the two superimposed components and becoming connected to the lower component by means of a friction-welding zone formed on the front side of the connecting part. The connecting part is provided, for this purpose, on its front side with a conical portion, wherein, out of consideration for the required penetration of the upper component, the surface of said conical portion has a cone angle between 5° and 10°, more particularly 7°, and the effect thereof being additionally supported by radially extending grooves of saw-tooth-shaped cross section.

The connection between steel and aluminium is likewise addressed in DE-OS 2 126 596, which initially describes an older known process in which an aluminium layer is applied to an aluminium part, for example by electroplating, whereupon the thus treated part is welded to another aluminium component. On the one hand, the application of the aluminium layer by electroplating is portrayed as disadvantageous because of reduced strength values; on the other hand, no further details are given concerning the execution of the actual welding operation, with the consequence that the teaching contained in said prior art is unproductive.

A further reference to the welding of cast aluminium parts to non-aluminium metal parts, e.g. parts made of steel, is described in DE-AS-27 52 584, in which two welding operations are executed consecutively, namely a first welding operation in the form of explosive welding to produce an aluminium layer on the nonaluminium metal part, followed by a second welding operation in order to join the two parts, wherein mention is made also of friction-welding, without the publication, however, making any disclosure whatsoever in relation to the concrete execution of such welding operation. At any rate, particularly on account of the need to execute two consecutive welding operations, said known process does not enter into consideration for fast automated production.

As is generally known, connections between steel and aluminium components through friction-welding are difficult to produce for the reason that friction-welding requires at least a plasticization of the two materials, wherein such plasticization operation must also include steel with its considerably higher melting point in comparison with aluminium.

The present invention adopts a different, special approach to the connecting of a rotationally symmetrical steel fastening element to a flat aluminium component, said approach being based on a friction-welding operation. The object of the invention is to prepare and design the fastening element in such a manner that the rotationally symmetrical steel fastening element can be attached in simple matter in a production process to a flat aluminium component.

The object of the invention is achieved in that the fastening element is provided with an electroplated aluminium coating and, at its end facing the component, forms a cone with a cone angle of at least α=174°, wherein, through rotation and pressing against the component, said cone is superficially connected thereto by means of a friction-welding zone.

The solution to the problem, therefore, consists essentially in providing the steel fastening element with an electroplated aluminium coating, which, of course, will without difficulty plasticize together with the aluminium component during the friction-welding operation and which can, if necessary, also be melted on, wherein, as experience has demonstrated, the at least plasticized aluminium will, in the region of its transition to the steel of the fastening element, diffuse thereinto, thereby forming a transitional region extending from the aluminium of the fastening element through the friction-welding zone in the region of the aluminium coating into the steel fastening element, this creating a secure friction-welded connection which can be quickly and easily produced within the framework of an automated fabrication process. In this regard, the aluminium coating offers the additional advantage of providing corrosion protection for the fastening element, with the consequence that said fastening element is also protected, in particular, against moisture, which would otherwise lead to the rusting of the fastening element.

An illustrative embodiment of the invention is presented in the drawings, in which:

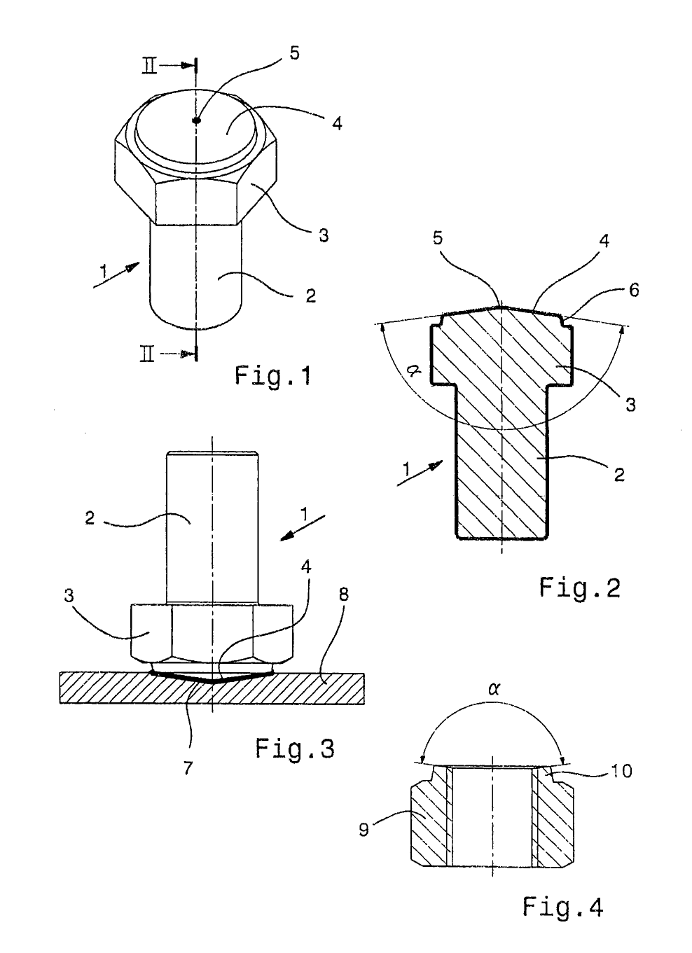

FIG. 1 shows the fastening element, in the form of a stud, in a perspective view;

FIG. 2 shows the fastening element in section along line II-II from FIG. 1;

FIG. 3 shows the same fastening element, connected to a panel by a friction-welding zone;

FIG. 4 shows the fastening element in the form of a nut.

FIG. 1 presents a perspective view of the steel stud 1, which is provided with the shank 2 and the flange 3. The flange 3 has a hexagonal contour by which it can be chucked in a tool for setting the stud 1 in rotation in known manner in order to execute the friction-welding operation. The end face 4 of the stud 1 is formed by a cone, the tip of which coincides with point 5. In this case, the cone angle is 174°, as is illustrated in FIG. 2.

FIG. 2 presents the stud in section. FIG. 2 clearly shows the design of the end face 4 in the form of a cone with conical tip 5. The cone has a cone angle of α=174°. When the stud 1 is applied to a flat component, the stud 1 first contacts the flat component with its tip 5, from where a friction-welding zone then spreads radially outwards until it reaches the edge 6 of the flange 3. The electroplated aluminium coating is represented in FIG. 2 by the thicker line of the outside contour.

FIG. 3 presents the stud 1 which has been connected by the friction-welding zone 7 to the aluminium panel 8. As is apparent, the connection of stud 1 through flange 4 to panel 8 is accomplished exclusively through the friction-welding zone 7, which extends superficially both over the end face 4 of the flange 3 and the surface of the component 8.

Owing to the aluminium coating of the stud 1, there initially results during friction-welding a plasticization at the contacting surfaces of end face 4 and component 8, whereby the aluminium of the coating becomes joined to the aluminium of the panel 8, the plasticized and possibly melted aluminium also penetrating into the material of the steel stud 1, this producing a genuine continuous metallic connection between panel 8 and stud 1. Decisive importance attaches in this regard not only to the aluminium coating of the component represented by the stud 1, but also to the particularly small cone angle a of the end face 4 of the stud, because it is the end face with its central point 5 that initially comes into contact with the panel 8 during the friction-welding operation, and where, on account of the greatly limited contact area, a relatively high temperature is quickly achieved with appropriate rotation of the stud 1, with the consequence that the central region of the flange 3 surrounding the tip 5 quickly heats up to the point of plasticization and beyond, so that, in view of the small cone angle, further outwardly disposed regions of the end face 4 of the flange 3 very quickly come into contact with the surface of the panel 8, this ultimately producing an exclusively two-dimensional, superficial contact over the entire end face 4 of the flange 3, with the consequence that the entire end face 4 becomes the friction-welding zone 7 with the panel 8.

The fastening element presented in FIG. 4 is an aluminium-coated steel nut 9 which is provided on one side with the annular projection 10, the end face of said annular projection 10 having an angle of α=174° according to the surface of a cone. Said end face then forms the friction-welded connection to a flat aluminium component, wherein, since the fastening element is in the form of a nut 9, upon its being applied to the component it is the annular outer edge of the projection 10 that makes contact with the component (which, in principle, is equivalent to the initial point contact between the stud 1 and a component 8 as presented in FIG. 3). When the nut 9 is applied to a component, there then takes place in principle the same friction-welding operation as was described in connection with FIG. 3 hereinbefore, this demonstrating that, according to the invention, it is not only a steel fastening element in the form of a stud, but also a steel fastening element in the form of a nut that can be connected to an aluminium panel by friction-welding, wherein the aluminium coating that is applied to the nut 9 has an identical effect to that described in connection with the stud 1 in FIG. 3.

What is claimed is:

1. Connection of a rotationally symmetrical steel fastening element (1, 9) to a flat aluminium component (8), characterized in that the fastening element (1, 9) is provided with an electroplated aluminium coating and, at its end facing the component, forms a cone with a cone angle of at least α=174°, wherein, through rotation and pressing against the component (8), said cone is superficially connected thereto by means of a friction-welding zone (7).
